(19) United States
(12) Patent Application Publication
(10) Pub. No.: US 2022/0245594 A1
(43) Pub. Date: Aug. 4, 2022

(54) METHOD AND SYSTEM FOR UNBIASED INTERVIEWING

(71) Applicant: Intuit Inc., Mountain View, CA (US)

(72) Inventor: Puja Baid, Marina Del Rey, CA (US)

(73) Assignee: Intuit Inc., Mountain View, CA (US)

(21) Appl. No.: 17/163,183

(22) Filed: Jan. 29, 2021

(51) Int. Cl. G06Q 10/10; G10L 21/013; G10L 13/033; G06K 9/00

(52) U.S. Cl. CPC G06Q 10/1053; G10L 21/013; G10L 2021/0135; G06K 9/00275; G10L 13/033

(57) ABSTRACT

A method for unbiased interviewing involves, during an interview of an interviewee: capturing an interviewee utterance, generating a voice-modulated interviewee utterance from the interviewee utterance, transmitting the voice-modulated interviewee utterance to an interviewer processing system, capturing an interviewee image, and transmitting the interviewee image to a backend processing system.

### BACKGROUND

Interviews, for example job interviews, are increasingly conducted using video conferencing tools, instead of being performed in-person. It may be desirable to use video conferencing tools for interviews in a manner reducing biases in the interview process, without removing the aspect of human interaction from the interviews.

### SUMMARY

In general, in one aspect, one or more embodiments relate to a method for unbiased interviewing, comprising: during an interview of an interviewee: capturing an interviewee utterance; generating a voice-modulated interviewee utterance from the interviewee utterance; transmitting the voice-modulated interviewee utterance to an interviewer processing system; capturing an interviewee image; and transmitting the interviewee image to a backend processing system.

In general, in one aspect, one or more embodiments relate to a method for unbiased interviewing, comprising: prior to an interview of an interviewee: obtaining a reference interviewee image; during the interview of the interviewee: receiving an interviewee image from an interviewee processing system; and comparing the interviewee image to the reference interviewee image to determine whether an identity mismatch is detected.

In general, in one aspect, one or more embodiments relate to a system for unbiased interviewing, the system comprising: a first computer processor of an interviewee processing system; and instructions executing on the first computer processor causing the interviewee processing system to: during an interview of an interviewee: capture an interviewee utterance, generate a voice-modulated interviewee utterance from the interviewee utterance, transmit the voice-modulated interviewee utterance to an interviewer processing system, capture an interviewee image, and transmit the interviewee image to a backend processing system.

Other aspects of the embodiments will be apparent from the following description and the appended claims.

### BRIEF DESCRIPTION OF DRAWINGS

FIG. 1 shows a system for unbiased interviewing, in accordance with one or more embodiments of the disclosure.

FIG. 2 shows an interviewee/interviewer processing system, in accordance with one or more embodiments of the disclosure.

FIG. 3 shows a backend processing system, in accordance with one or more embodiments of the disclosure.

FIG. 4A, FIG. 4B, and FIG. 4C show flowcharts describing methods for a processing performed by an interviewee processing system, in accordance with one or more embodiments of the disclosure.

FIGS. 5A and 5B show flowcharts describing methods for a processing performed by a backend processing system, in accordance with one or more embodiments of the disclosure.

FIG. 6A, FIG. 6B, and FIG. 6C show flowcharts describing methods for a processing performed by an interviewer processing system, in accordance with one or more embodiments of the disclosure.

FIGS. 7A and 7B show computing systems in accordance with one or more embodiments of the disclosure.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, although the description includes a discussion of various embodiments of the disclosure, the various disclosed embodiments may be combined in virtually any manner. All combinations are contemplated herein.

In general, embodiments of the disclosure enable an unbiased interviewing, e.g., job interviewing, using teleconferencing tools. Embodiments of the disclosure anonymize the interviewee, during the interview by the interviewer. The anonymization may include a voice modulation to anonymize the interviewee's voice. The anonymization may also include showing an avatar representing the interviewee to the interviewer, instead of providing an actual image of the interviewee. A similar anonymization may or may not be performed for the interviewer. Embodiments of the disclosure may, thus, reduce or eliminate a potential bias during the interview process. A detailed description is subsequently provided with reference to the figures.

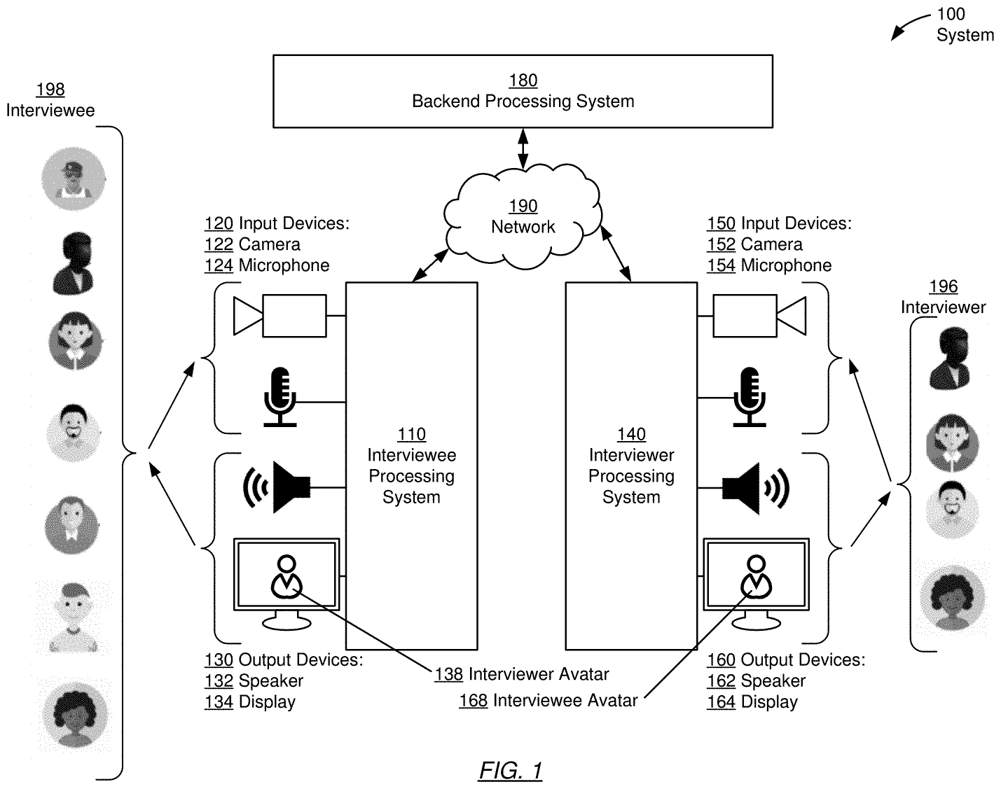

Turning to FIG. 1, a system (100) for unbiased interviewing, in accordance with one or more embodiments of the disclosure, is shown. Broadly speaking, the system (100) for unbiased interviewing may be implemented based on a videoconferencing solution, augmented by the addition of modules for anonymization and identity verification, as described below. The system (100) includes an interviewee processing system (110), one or more input devices (120) and one or more output devices (130) interfacing with the interviewee processing system (110). The system (100) further includes an interviewer processing system (140), one or more input devices (150) and one or more output devices (160) interfacing with the interviewer processing system (140). The system (100) further includes a backend processing system (180). Each of these components is subsequently described.

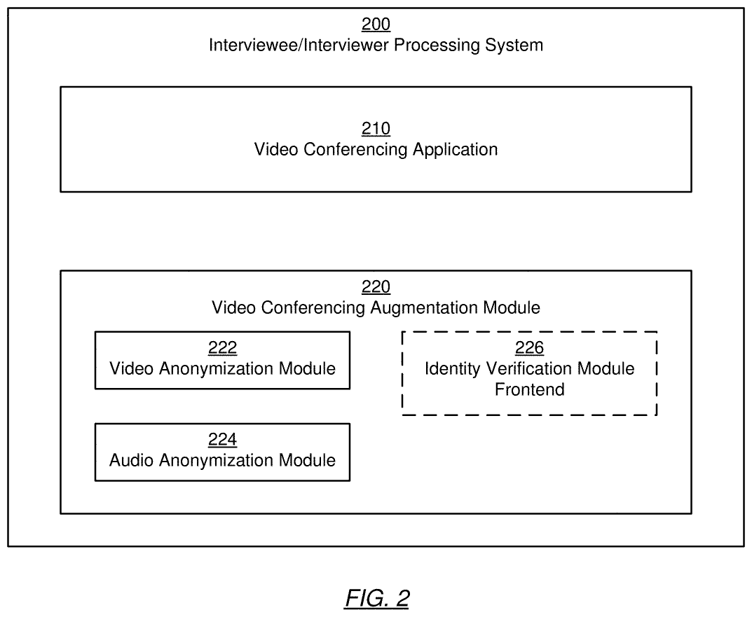

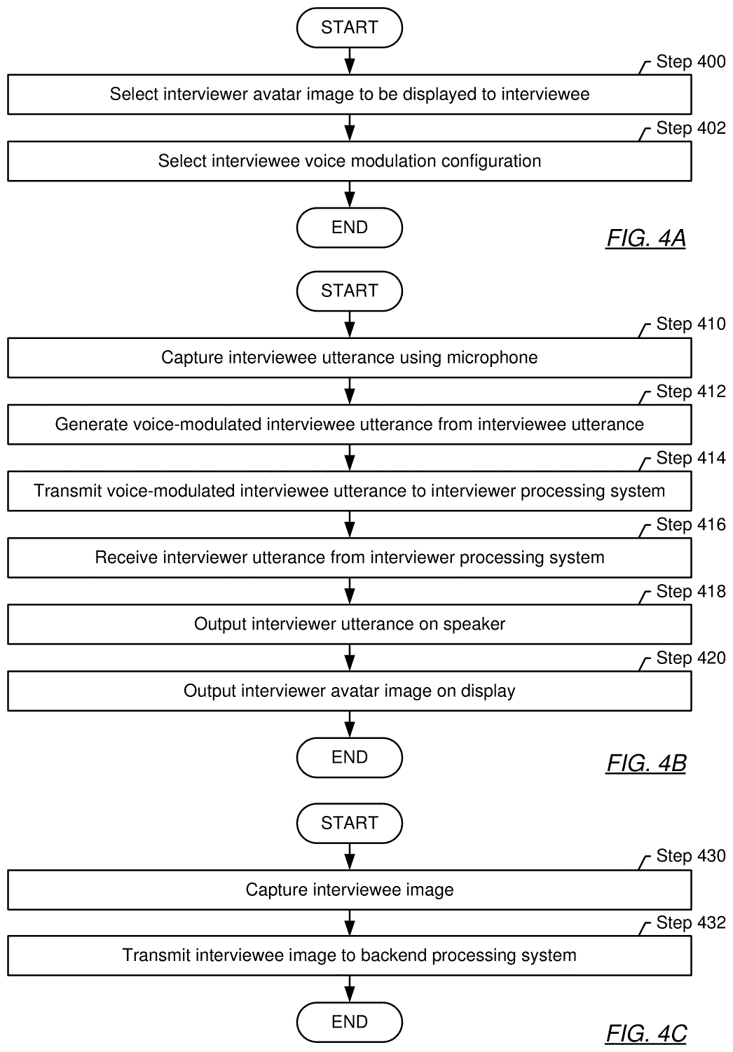

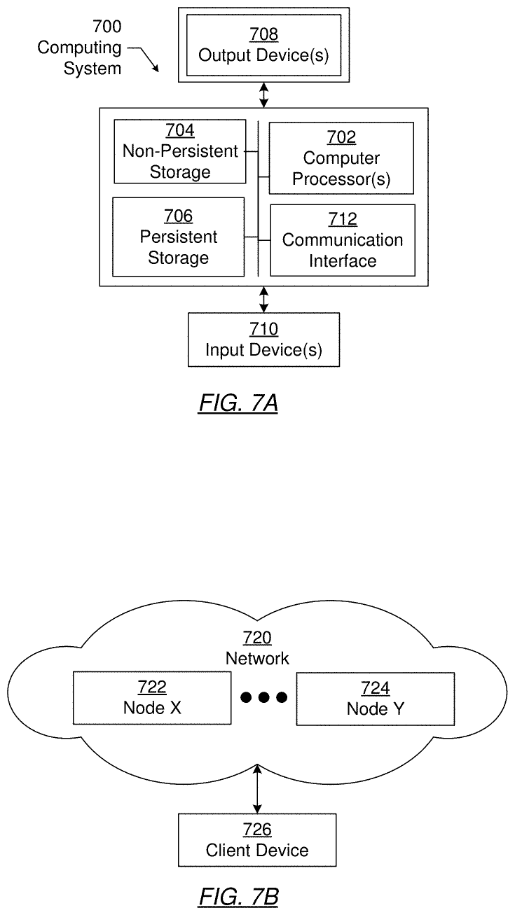

The interviewee processing system (110), in one or more embodiments, enables an interviewee (198) to participate in an interview. The interviewee processing system (110) may be based on a personal computer, a laptop, a tablet computer, a smartphone, and may include various components of a computing system as described in reference to FIGS. 7A and 7B. Components of the interviewee processing system (110) are described in reference to FIG. 2. The interviewee processing system (110) includes a set of machine-readable instructions (stored on a computer-readable medium) which when executed may perform one or more operations, described in reference to the flowcharts of FIGS. 4A, 4B, and 4C.

Input devices (120) and output devices (130) associated with the interviewee processing system (110) may enable an interviewee (198) to participate in the interview.

More specifically, a camera (122) may be provided to capture one or more images or a video of the interviewee (198). The camera may be any type of camera, for example, a webcam built into the computing system of the interviewee processing system (110), or an external camera interfacing with the computing system. A microphone (124) may be provided to capture the interviewee's speech during an interview. The microphone (124) may be any type of microphone, for example, a microphone built into the computing system of the interviewee processing system (110), or an external microphone interfacing with the computing system. The microphone (124) may be part of a communication headset worn by the interviewee. A speaker (132) may be provided to output audio, to the interviewee. The speaker (132) may be any type of speaker, for example, a speaker built into the computing system of the interviewee processing system (110), or an external speaker interfacing with the computing system. The speaker (132) may be part of a communication headset worn by the interviewee. In combination, the speaker (132) and the microphone (124) may enable a conversation between the interviewee (198) and the interviewer (196). In one embodiment, the voice of the interviewer (196) is modulated to provide an anonymization of the interviewer. Alternatively, the voice of the interviewer (196) may not be anonymized. A display (134) may be provided to output image content to the interviewee (198). The image content, in one or more embodiments, excludes a still image or video of the interviewer (196), to anonymize the interviewer (196). A neutral image, e.g., an interviewer avatar (138), a logo, or any other symbol may be displayed instead of an image of the interviewer (196). Alternatively, the interviewer (196) may not be anonymized. Other content, such as shared documents, may also be displayed, using the display (134). The display may be any type of display, for example, a display built into the computing system of the interviewee processing system (110), or an external display interfacing with the computing system.

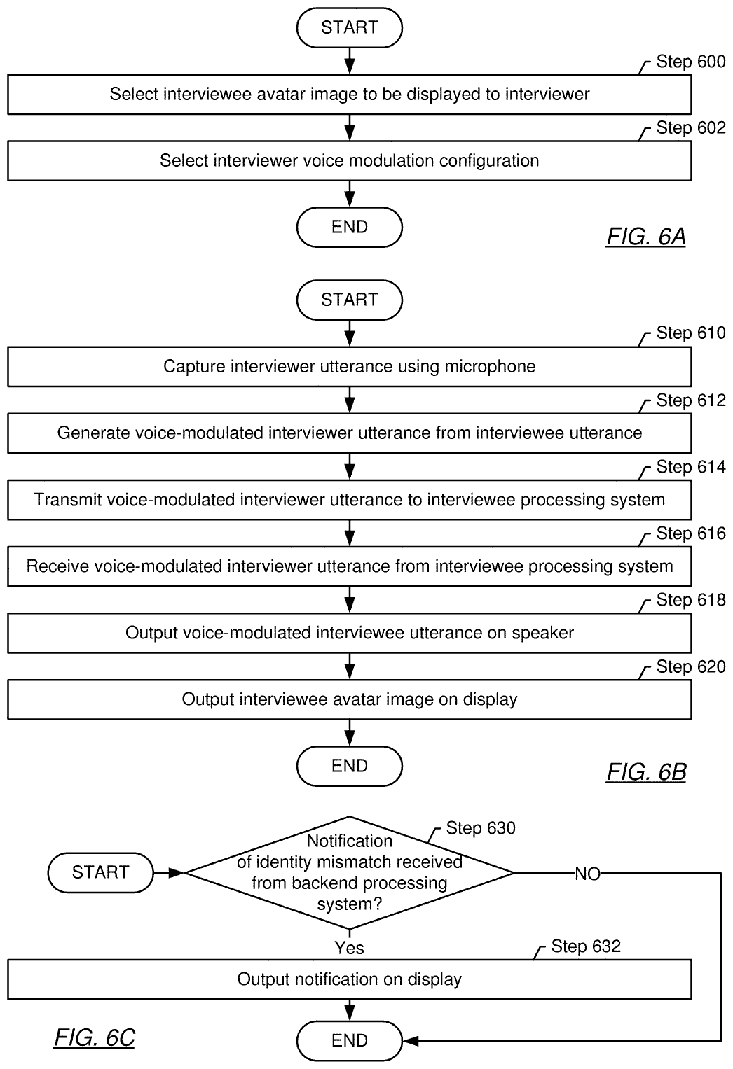

The interviewer processing system (140), in one or more embodiments, enables an interviewer (196) to participate in an interview. The interviewer processing system (140) may be based on a personal computer, a laptop, a tablet computer, a smartphone, and may include various components of a computing system as described in reference to FIGS. 7A and 7B. Components of the interviewer processing system (140) are described in reference to FIG. 2. The interviewer processing system (140) includes a set of machine-readable instructions (stored on a computer-readable medium) which when executed may perform one or more operations, described in reference to the flowcharts of FIGS. 6A, 6B, and 6C.

Input devices (150) and output devices (160) associated with the interviewer processing system (140) may enable an interviewer (196) to participate in the interview.

More specifically, a camera (152) may be provided to capture one or more images or a video of the interviewer (168). The camera may be any type of camera, for example, a webcam built into the computing system of the interviewer processing system (140), or an external camera interfacing with the computing system. A camera (152) is not necessarily present. A microphone (154) may be provided to capture the interviewer's speech during an interview. The microphone (154) may be any type of microphone, for example, a microphone built into the computing system of the interviewer processing system (140), or an external microphone interfacing with the computing system. The microphone (154) may be part of a communication headset worn by the interviewer. A speaker (162) may be provided to output audio, to the interviewer. The speaker (162) may be any type of speaker, for example, a speaker built into the computing system of the interviewer processing system (140), or an external speaker interfacing with the computing system. The speaker (162) may be part of a communication headset worn by the interviewer. In combination, the speaker (162) and the microphone (154) may enable a conversation between the interviewee (198) and the interviewer (196). In one embodiment, the voice of the interviewee (198) is modulated to provide an anonymization of the interviewee. A display (164) may be provided to output image content to the interviewer (196). The image content, in one or more embodiments, excludes a still image or video of the interviewee (198), to ensure anonymization. A neutral image, e.g., an interviewee avatar (168), a logo, or any other symbol may be displayed instead of an image of the interviewee (198). Other content, such as shared documents may also be displayed, using the display (164). The display may be any type of display, for example, a display built into the computing system of the interviewer processing system (140), or an external display interfacing with the computing system.

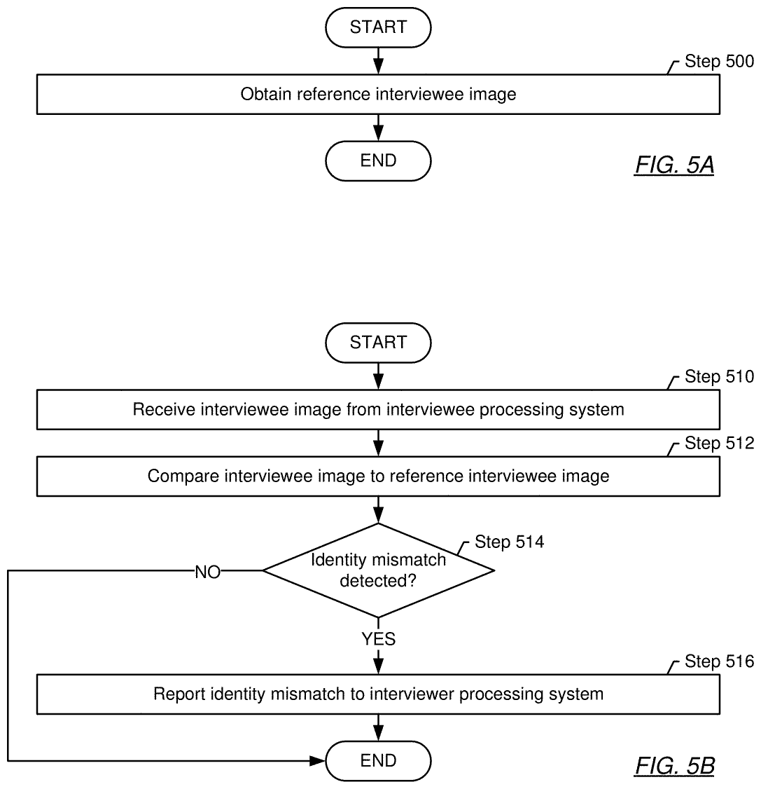

The backend processing system (180), in one or more embodiments, provides functionality to prevent fraud when an interview is conducted while the identity of the interviewee is anonymized. Specifically, the backend processing system (180) includes a set of machine-readable instructions (stored on a computer-readable medium) which when executed implement a method for verifying the interviewee's identity, during the interview, as described below in reference to the flowcharts of FIGS. 5A and 5B, without disclosing the identity to the interviewer. Fraudulent completion of the interview by a person different from the interviewee originally intended to be interviewed may, thus, be prevented. The backend processing system (180) may be cloud-based or may be located on any other computing system, e.g., a server, as described in reference to FIGS. 7A and 7B.

The interviewee processing system (110) the interviewer processing system (140), and the backend processing system (180) may communicate using any combination of wired and/or wireless communication protocols via a network (190). The network (190) may include a wide area network (e.g., the Internet), and/or a local area network (e.g., an enterprise or home network).

Turning to FIG. 2, an interviewee/interviewer processing system (200), in accordance with one or more embodiments, is shown. The interviewee/interviewer processing system (200) may correspond to the interviewee processing system (110) and the interviewer processing system (140) of FIG. 1.

In one or more embodiments, the interviewee/interviewer processing system (200) includes a video conferencing application (210) and a video conferencing augmentation module (220) interfacing with the video conferencing application (210).

The video conferencing application (210) may be based on video conferencing solutions such as Zoom, BlueJeans Meetings, Microsoft Teams, GoToMeeting, or a custom video conferencing application. The video conferencing may provide various functionalities such a bidirectional video and audio communication, sharing of documents, etc.

In one or more embodiments, the video conferencing augmentation module (220) is interfacing with or integrated with the video conferencing application. The interfacing or integration may be performed using an application programming interface (API) or a software development kit (SDK). The video conferencing augmentation module (220) interacts with the video conferencing application (210) to modify the operation of the video conferencing application (210) in various aspects, as subsequently described. In particular, the video conferencing augmentation module (220), in one or more embodiments, provides functionalities that increase the likeliness that interviews can be conducted in a less biased or non-biased manner, while still being secure.

The video anonymization module (222), in one or more embodiments, prevents transmission of images or videos by the interviewee/interviewer processing system (200) as subsequently described.

When the interviewee/interviewer processing system (200) operates as the interviewee processing system (110), the video anonymization module (222) prevents transmission of images or videos captured by the camera (122) to the interviewer processing system (140). A placeholder image or video, or no image or video may be transmitted. Further, when the interviewee processing system (110) does not receive image or video data from the interviewer processing system (140), the video anonymization module (222) may cause the video conferencing application (210) to output a neutral image, e.g., the interviewer avatar (138), on the display (134) of the interviewee processing system (110). As a result of the anonymization, the interviewer (196) may not be biased by the visual appearance of the interviewee (198).

When the interviewee/interviewer processing system (200) operates as the interviewer processing system (140), the video anonymization module (222) prevents transmission of images or videos captured by the camera (152) to the interviewee processing system (110). A placeholder image or video, or no image or video may be transmitted. Further, when the interviewer processing system (140) does not receive image or video data from the interviewee processing system (110), the video anonymization module (222) may cause the video conferencing application (210) to output a neutral image, e.g., the interviewee avatar (168), on the display (164) of the interviewer processing system (140). As a result of the anonymization, the interviewee (198) may not be biased by the visual appearance of the interviewer (196). If a bias of the interviewee (198) is not a concern, the video anonymization module (222) of the interviewer processing system (140) may be deactivated.

The audio anonymization module (222), in one or more embodiments, modulates the voice input received via the microphone. The modulation may be performed in real-time or near real-time. Amplitude, pitch and/or tone of the voice may be modulated. The modulation may be used to change a male voice into a female voice, and vice versa, and/or to introduce other distortions. Those skilled in the art will appreciate that many methods for voice modulation exist, any of which may be used to implement the audio anonymization module (222). Alternatively, a real-time translation approach may be used to perform a speech-to-speech translation that modulates the voice, changes intonation, pronunciation, etc. In this implementation, the audio anonymization module (222) may also perform a translation to a different language, if desired.

When the interviewee/interviewer processing system (200) operates as the interviewee processing system (110), the audio anonymization module (222) modulates the voice of the interviewee (198), received via the microphone (124). The interviewer (196), in one or more embodiments, receives the voice-modulated voice of the interviewee (198), to reduce or eliminate a voice-based bias of the interviewer (196).

When the interviewee/interviewer processing system (200) operates as the interviewer processing system (140), the audio anonymization module (222) modulates the voice of the interviewer (196), received via the microphone (154). The interviewee (198), in one or more embodiments, receives the voice-modulated voice of the interviewer (196), to reduce or eliminate a voice-based bias of the interviewee (198). If a bias of the interviewee (198) is not a concern, the audio anonymization module (224) of the interviewer processing system (140) may be deactivated.

To further reduce the risk of interviewing bias, the type of voice modulation may be altered, e.g., between multiple rounds of interviews of the interviewee (198). For example, a female voice may be used in one round, and a male voice may be used in another round.

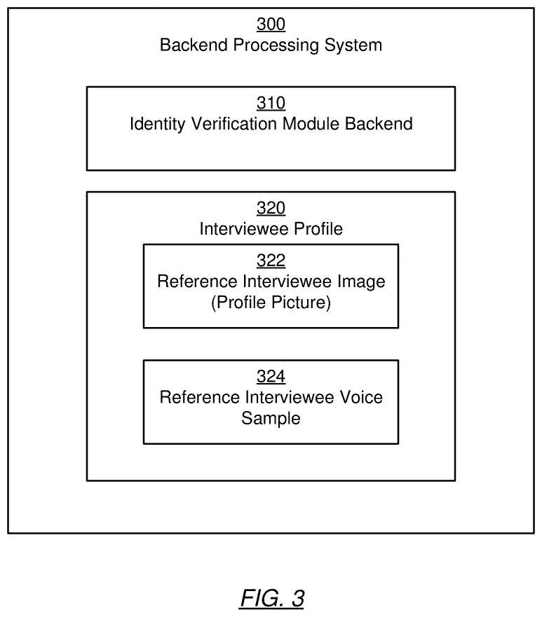

The identity verification module frontend (226), in one or more embodiments, is configured to confirm the identity of the interviewee (198) even though the interviewer (196) does not receive an image or video of the interviewee (198) during an interview. The identity verification module frontend (226) operates in conjunction with an identity verification module backend of the backend processing system, described in reference to FIG. 3. The identity verification module frontend (226) may collect image or video data, e.g., single image frames or series of image frames and may transmit the image or video data to the identity verification module backend of the backend processing system, where the identity of the interviewee (198) may be verified. Additionally or alternatively, voice samples of the interviewee's original voice (prior to the voice modulation) may also be collected and transmitted to perform an identify verification. No identity verification module frontend (226) may be provided for the interviewer processing system (140).

Turning to FIG. 3, a backend processing system (300), in accordance with one or more embodiments, is shown. The backend processing system (300) may correspond to the backend processing system (180) of FIG. 1. The backend processing system (300) includes an identity verification module backend (310), and an interviewee profile (320). Elements of the interviewee profile (320) may be used by the identity verification module backend (310) to confirm the identity of the interviewee, despite the anonymization preventing the interviewer from confirming the interviewee's identity.

In one or more embodiments, the interviewee profile (320) includes a reference interviewee image (322). The reference interviewee image (322), in one or more embodiments, is assumed to reflect the current appearance of the interviewee, such that the interviewee's identity can be confirmed by comparison of an image captured during the interview with the reference interviewee image. The reference interviewee image (322) may be obtained in any manner, prior to the interview. For example, the reference interviewee image may have been provided by the interviewee, may have been obtained through a web search, by accessing social media and/or professional networks, etc. If the identity verification module backend (320) is configured to confirm the interviewee's identity based on speech, the interviewee profile (320) may include a reference interviewee voice sample (324). In one or more embodiments, the interviewee profile (320), including the reference interviewee image (322) and the reference interviewee voice sample (324) are obtained through a hiring portal. The interviewee profile (320) may be generated a few days prior to the interview, through the hiring portal. The interviewee profile (320), after the interview, may be deleted or archived.

In one or more embodiments, the identity verification module backend (310), upon receiving an image of the interviewee, compares the received image with the reference interviewee image to confirm the interviewee's identity. The comparison may be performed using any suitable face recognition algorithm including classical approaches based on holistic or local features, artificial neural networks-based approaches, Gabor wavelet-based approaches, face descriptor-based approaches, video-based approaches, etc. The output may be a variable indicating whether the identity is confirmed or not. Alternatively, a probability may be provided. A threshold may be applied to the probability to confirm or reject the identity of the interviewee.

Additionally or alternatively, the identify verification module backend (310), upon receiving an interviewee voice sample captured during an ongoing interview, compares the received interviewee voice sample with the reference interviewee voice sample to confirm the interviewee's identity. The comparison may be performed using any suitable speaker recognition algorithm including approaches that are based on frequency estimations, hidden Markov models, Gaussian mixture models, pattern matching algorithms, artificial neural networks, matrix representations, vector quantizations, decision trees, cosine similarity, etc. The output may be a variable indicating whether the identity is confirmed or not. Alternatively, a probability may be provided. A threshold may be applied to the probability to confirm or reject the identity of the interviewee.

While FIGS. 1, 2, and 3 show configurations of components, other configurations may be used without departing from the scope of the disclosure. For example, various components may be combined to create a single component. As another example, the functionality performed by a single component may be performed by two or more components. Further, additional components, e.g., a scheduling system to enable setting up interviews, a recording system to record interviews, etc., may be included, without departing from the disclosure.

FIGS. 4A, 4B, 4C, 5A, 5B, 6A, 6B, and 6C show flowcharts in accordance with one or more embodiments of the disclosure. While the various steps in these flowcharts are provided and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the disclosure. By way of an example, determination steps may not require a processor to process an instruction unless an interrupt is received to signify that condition exists in accordance with one or more embodiments of the disclosure. As another example, determination steps may be performed by performing a test, such as checking a data value to test whether the value is consistent with the tested condition in accordance with one or more embodiments of the disclosure.

FIGS. 4A, 4B, and 4C show flowcharts describing methods for a processing performed by an interviewee processing system, in accordance with one or more embodiments of the disclosure.

Turning to FIG. 4A, a flowchart describing a method for initializing the interviewee processing system, in accordance with one or more embodiments, is shown. The steps described in FIG. 4A may be performed in addition to other operations. In other words, other steps may be performed in addition, when initializing the interviewee processing system. The steps described in FIG. 4A may be performed prior to conducting the interview of the interviewee.

In Step 400, an interviewer avatar image to be displayed to the interviewee is selected. The interviewer avatar image may be randomly selected from a set of avatar images. As a result of the random selection, different avatar images may be selected for different interview rounds to further reduce the possibility of visual bias. Alternatively, the interviewer avatar image may be manually set, e.g., based on a selection by the interviewer.

In Step 402, an interviewee voice modulation configuration is selected. The interviewee voice modulation configuration may be randomly selected from a set of voice modulation configurations. Alternatively, the interviewee voice modulation configuration may be manually selected, e.g., by the interviewee. As a result of the random selection, different voice modulation configurations may be selected for different interview rounds to further reduce the possibility of voice-based bias. The content of the interviewee voice modulation configuration depends on the type of voice modulation to be performed. For example, different settings for amplitude, pitch, and/or tone may be specified by different voice modulation configurations. If the interviewee voice modulation involves translation to a different language, a target language may be specified.

Turning to FIG. 4B, a flowchart describing a method for operating the interviewee processing system, in accordance with one or more embodiments, is shown. The steps described in FIG. 4B may be performed in addition to other operations. In other words, other steps may be performed in addition, when operating the interviewee processing system. The steps described in FIG. 4B may be continuously performed while conducting the interview of the interviewee.

In Step 410, an interviewee utterance is captured using the microphone associated with the interviewee processing system. The interviewee utterance may be spoken language of the interviewee as the interview is conducted.

In Step 412, a voice-modulated interviewee utterance is generated from the interviewee utterance. The voice modulation in Step 412 may be performed based on the interviewee voice modulation configuration obtained in Step 402. The operation of Step 412 may be performed in real-time or near real-time.

In Step 414, the voice-modulated interviewee utterance is transmitted to the interviewer processing system.

In Step 416, an interviewer utterance is received from the interviewer processing system. Depending on the configuration of the interviewer processing system, the interviewer utterance may or may not be voice-modulated.

In Step 418, the interviewer utterance is provided to the interviewee via the speaker of the interviewee processing system.

In Step 420, the interviewer avatar image is displayed to the interviewee on the display of the interviewee processing system.

Turning to FIG. 4C, a flowchart describing a method for operating the interviewee processing system, in accordance with one or more embodiments, is shown. The steps described in FIG. 4C may be performed in addition to other operations. In other words, other steps may be performed in addition, when operating the interviewee processing system. The steps described in FIG. 4C may be periodically performed while conducting the interview of the interviewee. For example, the steps described in FIG. 4C may be performed in ten second intervals, one-minute intervals, or any other time interval.

In Step 430, an interviewee image is captured. The image of the interviewee may be captured using the camera associated with the interviewee processing system.

In Step 432, the interviewee image is transmitted to the backend processing system.

While not shown, a voice sample may also be captured during the interview. The captured voice sample may be transmitted to the backend processing system.

FIGS. 5A and 5B show flowcharts describing methods for a processing performed by a backend system, in accordance with one or more embodiments of the disclosure.

Turning to FIG. 5A, a flowchart describing a method for initializing the backend processing system, in accordance with one or more embodiments, is shown. The step described in FIG. 5A may be performed in addition to other operations. In other words, other steps may be performed in addition, when initializing the backend processing system. The step described in FIG. 5A may be performed prior to conducting the interview of the interviewee.

In Step 500, a reference interviewee image is obtained. The reference interviewee image may be obtained from any source, e.g., the interviewee, social media, professional networks, other online resources, etc. While not shown, a reference interviewee voice sample may also be obtained, if the backend processing system is configured to confirm the identity of the interviewee by analyzing a voice sample.

Turning to FIG. 5B, a flowchart describing a method for operating the backend processing system, in accordance with one or more embodiments, is shown. The steps described in FIG. 5B may be performed in addition to other operations. In other words, other steps may be performed in addition, when operating the backend processing system. The steps described in FIG. 5B may be periodically performed. More specifically, the steps described in FIG. 5B may be performed when an interviewee image is received in Step 510. Otherwise, the method of FIG. 5B may not execute.

In Step 510, the interviewee image is received from the interviewee processing system. While not shown, optionally, a voice sample may be received.

In Step 512, the interviewee image is compared to the reference interviewee image, by the identity verification module, as described in reference to FIG. 3. While not shown, optionally, the voice sample may be compared to a reference interviewee voice sample. The output of the comparison(s) may indicate whether the identity of the interviewee is confirmed or rejected.

In Step 514, if an identity mismatch is detected, i.e., the identity of the interviewee was not confirmed, in Step 512, the method may proceed with the execution of Step 516.

In Step 516, the identity mismatch is reported to the interviewer processing system. The reporting may be performed by sending a message, setting a flag, etc.

After completion of the interview, any personal data, e.g., interviewee images and/or voice samples may be deleted. The interviewee profile (320), after the interview, may be deleted or archived. Other steps may be performed as necessary to comply with privacy laws and/or policies.

FIGS. 6A, 6B, and 6C show flowcharts describing methods for a processing performed by an interviewer processing system, in accordance with one or more embodiments of the disclosure.

Turning to FIG. 6A, a flowchart describing a method for initializing the interviewer processing system, in accordance with one or more embodiments, is shown. The steps described in FIG. 6A may be performed in addition to other operations. In other words, other steps may be performed in addition, when initializing the interviewer processing system. The steps described in FIG. 6A may be performed prior to conducting the interview of the interviewee.

In Step 600, an interviewee avatar image to be displayed to the interviewer is selected. The interviewee avatar image may be randomly selected from a set of avatar images. As a result of the random selection, different avatar images may be selected for different interview rounds to further reduce the possibility of visual bias. Alternatively, the interviewee avatar image may be manually set, e.g., based on a selection by the interviewee.

In Step 602, an interviewer voice modulation configuration is selected. The interviewer voice modulation configuration may be randomly selected from a set of voice modulation configurations. As a result of the random selection, different voice modulation configurations may be selected for different interview rounds to further reduce the possibility of voice-based bias. Alternatively, the interviewer voice modulation configuration may be manually selected, e.g., by the interviewer. The content of the interviewer voice modulation configuration depends on the type of voice modulation to be performed. For example, different settings for amplitude, pitch, and/or tone may be specified by different voice modulation configurations. If the interviewer voice modulation involves translation to a different language, a target language may be specified.

Turning to FIG. 6B, a flowchart describing a method for operating the interviewer processing system, in accordance with one or more embodiments, is shown. The steps described in FIG. 6B may be performed in addition to other operations. In other words, other steps may be performed in addition, when operating the interviewer processing system. The steps described in FIG. 6B may be repeatedly or continuously performed while conducting the interview of the interviewee.

In Step 610, an interviewer utterance is captured using the microphone associated with the interviewer processing system. The interviewer utterance may be spoken language of the interviewer as the interview is conducted.

In Step 612, a voice-modulated interviewer utterance is generated from the interviewer utterance. The voice modulation in Step 612 may be performed based on the interviewer voice modulation configuration obtained in Step 602. The operation of Step 612 may be performed in real-time or near real-time. The execution of Step 612 is optional.

In Step 614, the voice-modulated interviewer utterance is transmitted to the interviewee processing system. If Step 612 is skipped, then the interviewer utterance without voice modulation is transmitted.

In Step 616, a voice-modulated interviewee utterance is received from the interviewee processing system.

In Step 618, the voice-modulated interviewee utterance is provided to the interviewer via the speaker of the interviewer processing system.

In Step 620, the interviewee avatar image is displayed to the interviewer on the display of the interviewer processing system.

Turning to FIG. 6C, a flowchart describing a method for operating the interviewer processing system, in accordance with one or more embodiments, is shown. The steps described in FIG. 6C may be performed in addition to other operations. In other words, other steps may be performed in addition, when operating the interviewer processing system. The steps described in FIG. 6C may be performed when triggered by receiving a notification from the backend system, indicating that an identity mismatch was detected.

In Step 630 a test is performed to determine whether a notification from the backend system, indicating that an identity mismatch was detected, has been received. The execution of the method may proceed with Step 632, only if the notification has been received.

In Step 632, the notification is provided in the display associated with the interviewer processing system to the interviewer.

While the flowcharts describe an interactive interview process, an interview may alternatively be conducted offline. More specifically, statements by the interviewer and/or the interviewee may be recorded. For example, the interviewer's questions may be recorded, and/or the interviewee's answers may be recorded using embodiments as previously described. The evaluation of the interviewee may then be separately performed, e.g., at a later time, based on the recordings, while still providing the anonymization as described.

Embodiments of the disclosure enable an unbiased or less biased interviewing of an interviewee, based on the anonymization of the interviewee. Factors that are thought to be triggering an interview bias, including but not limited to appearance, gender, age, voice may be neutralized using embodiments of the disclosure. The interviewer may also be anonymized. To further reduce the possibility of bias, the parameters used for the anonymization, e.g., the type of voice modulation being used during an interview, may be varied between interview rounds. Despite the anonymization, the integrity of the interview is ensured by the verification of the interviewee's identity during the interview. Further, despite the anonymization, the interview may be conducted similar to a non-anonymized interview, and may involve elements such as spoken language interactions, skill demonstrations including coding, system design, business use case analysis, etc. Embodiments of the disclosure may further be used to evaluate the fairness of an interviewer. Specifically, interview results obtained from an interviewer interviewing an interviewee may be compared to identify whether certain types of voice modulation or other factors affect (positively or negatively) the rating of an interviewee by the interviewer. For example, an analysis of the interview results may reveal that the interviewer, consciously or subconsciously, rates candidates with a male voice higher than candidates with a female voice. A change in bias may be determined when comparing conventional interviews vs interviews conducted in accordance with the described embodiments. More generally, based on the interview results, the interviewer profile, the interviewee profile, insights may be derived. These insights may also include predictions regarding future performance of the interviewee.

Embodiments of the disclosure may be implemented on a computing system. Any combination of mobile, desktop, server, router, switch, embedded device, or other types of hardware may be used. For example, as shown in FIG. 7A, the computing system (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), and numerous other elements and functionalities.

The computer processor(s) (702) may be an integrated circuit for processing instructions. For example, the computer processor(s) may be one or more cores or micro-cores of a processor. The computing system (700) may also include one or more input devices (710), such as a touchscreen, keyboard, mouse, microphone, touchpad, electronic pen, or any other type of input device.

The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the computing system (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system shown in FIG. 7A, or a group of nodes combined may correspond to the computing system shown in FIG. 7A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (700) may be located at a remote location and connected to the other elements over a network.

Although not shown in FIG. 7B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (722), node Y (724)) in the network (720) may be configured to provide services for a client device (726). For example, the nodes may be part of a cloud computing system. The nodes may include functionality to receive requests from the client device (726) and transmit responses to the client device (726). The client device (726) may be a computing system, such as the computing system shown in FIG. 7A. Further, the client device (726) may include and/or perform all or a portion of one or more embodiments of the disclosure.

The computing system or group of computing systems described in FIGS. 7A and 7B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel endpoints enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system in FIG. 7A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query provided to a structured data repository (where the data repository may be organized according to a database schema or data format, such as XML).

The extracted data may be used for further processing by the computing system. For example, the computing system of FIG. 7A, while performing one or more embodiments of the disclosure, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 7A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 7A may include functionality to provide raw and/or processed data, such as results of comparisons and other processing. For example, providing data may be accomplished through various presenting methods. Specifically, data may be provided through a user interface provided by a computing device. The user interface may include a GUI that displays information on a display device, such as a computer monitor or a touchscreen on a handheld computer device. The GUI may include various GUI widgets that organize what data is shown as well as how data is provided to a user. Furthermore, the GUI may provide data directly to the user, e.g., data provided as actual data values through text, or rendered by the computing device into a visual representation of the data, such as through visualizing a data model.

For example, a GUI may first obtain a notification from a software application requesting that a particular data object be provided within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be provided through various audio methods. In particular, data may be rendered into an audio format and provided as sound through one or more speakers operably connected to a computing device.

Data may also be provided to a user through haptic methods. For example, haptic methods may include vibrations or other physical signals generated by the computing system. For example, data may be provided to a user using a vibration generated by a handheld computer device with a predefined duration and intensity of the vibration to communicate the data.

The above description of functions presents only a few examples of functions performed by the computing system of FIG. 7A and the nodes and/or client device in FIG. 7B. Other functions may be performed using one or more embodiments of the disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for unbiased interviewing, comprising:
during an interview of an interviewee:
capturing an utterance of the interviewee;
generating a voice-modulated utterance of the interviewee from the utterance of the interviewee;
transmitting the voice-modulated utterance to an interviewer processing system;
capturing an image of the interviewee; and
transmitting the image of the interviewee to a backend processing system.

2. The method of claim 1, further comprising:
receiving an utterance of an interviewer from the interviewer processing system; and
outputting the utterance of the interviewer on a speaker.

3. The method of claim 2, wherein the is voice-modulated.

4. The method of claim 1, further comprising:
outputting an interviewer avatar image on a display.

5. The method of claim 4, further comprising:
prior to the interview of the interviewee:
selecting the interviewer avatar image.

6. The method of claim 1, further comprising:
prior to the interview of the interviewee:
selecting an interviewee voice modulation configuration for the voice modulation of the utterance of the interviewee.

7. The method of claim 1, wherein generating the voice-modulated utterance of the interviewee comprises modulating at least one selected from the group consisting of amplitude, pitch, and tone.

8. The method of claim 1, wherein generating the voice-modulated utterance of the interviewee comprises performing a translation to a different language.

9. A method for unbiased interviewing, comprising:
prior to an interview of an interviewee:
obtaining a reference image of the interviewee;
during the interview of the interviewee:
receiving an image of the interviewee from an interviewee processing system; and
comparing the image of the interviewee to the reference image of the interviewee to determine whether an identity mismatch is detected.

10. The method of claim 9, further comprising:
reporting the identity mismatch to an interviewer processing system, when the identity mismatch is detected.

11. The method of claim 9, further comprising:
receiving a voice sample of the interviewee captured during the interview; and
comparing the voice sample of the interviewee with a reference voice sample of the interviewee to determine whether the identity mismatch is detected.

12. The method of claim 9,
wherein the receiving of the image of the interviewee and the comparing of the image of the interviewee to the reference image of the interviewee are periodically performed, during the interview.

13. The method of claim 9, wherein comparing the image of the interviewee to the reference image of the interviewee is performed by a face recognition algorithm.

14. A system for unbiased interviewing, the system comprising:
a first computer processor of an interviewee processing system; and
instructions executing on the first computer processor causing the interviewee processing system to:
during an interview of an interviewee:
capture an utterance of the interviewee,
generate a voice-modulated utterance of the interviewee from the utterance of the interviewee,
transmit the voice-modulated utterance of the interviewee to an interviewer processing system,
capture an image of the interviewee, and
transmit the image of the interviewee to a backend processing system.

15. The system of claim 14, further comprising:
a second computer processor of the backend processing system; and
instructions executing on the second computer processor causing the backend processing system to:
prior to the interview of the interviewee:
obtain a reference image of the interviewee,
during the interview of the interviewee:
receive the image of the interviewee from the interviewee processing system, and
compare the image of the interviewee to the reference image of the interviewee to determine whether an identity mismatch is detected.

16. The system of claim 15, wherein the receiving of the image of the interviewee and the comparing the image of the interviewee to the reference image of the interviewee are periodically performed, during the interview.

17. The system of claim 15, wherein the instructions executing on the second computer processor further cause the backend processing system to:
transmit a notification reporting the identity mismatch to the interviewer processing system, when the identity mismatch is detected.

18. The system of claim 14, further comprising:
a third computer processor of the interviewer processing system; and
instructions executing on the third computer processor causing the interviewer processing system to:
during the interview of the interviewee:
capture an utterance of an interviewer,
transmit the utterance of the interviewer to the interviewee processing system,
receive the voice-modulated utterance of the interviewee from the interviewee processing system, and
output the voice-modulated utterance of the interviewee on a speaker of the interviewer processing system.

19. The system of claim 18, wherein the instructions executing on the third computer processor further cause the interviewer processing system to:
voice-modulate the utterance of the interviewer, prior to transmitting the utterance of the interviewer.

20. The system of claim 18, wherein the instructions executing on the third computer processor further cause the interviewer processing system to:
receive a notification of an identity mismatch from the backend processing system; and
based on receiving the notification, output the notification on a display of the interviewer processing system.
